(19) United States
(12) Patent Application Publication
(10) Pub. No.: US 2023/0203739 A1
(43) Pub. Date: Jun. 29, 2023

(54) FLUID DEVICE, PARTICLE REMOVAL APPARATUS, AND WASHING MACHINE

(71) Applicant: SEIKO EPSON CORPORATION, TOKYO (JP)

(72) Inventors: Chikara KOJIMA, Matsumoto-shi (JP); Tomohide ONOGI, Shiojiri-shi (JP)

(21) Appl. No.: 18/145,864

(22) Filed: Dec. 23, 2022

(30) Foreign Application Priority Data
Dec. 24, 2021 (JP) 2021210531

(51) Int. Cl. D06F 39/10; D06F 39/08; C02F 1/36; B06B 1/06

(52) U.S. Cl. CPC D06F 39/10; D06F 39/083; C02F 1/36; B06B 1/0622; C02F 2103/002

(57) ABSTRACT

A fluid device includes: a first flow path that extends along a first axis and through which a fluid flows in a positive side of the first axis; a first ultrasonic element configured to generate a first standing wave along a second axis orthogonal to the first axis in the first flow path; and a second flow path connected to the first flow path such that the fluid flows therethrough and extending along a third axis intersecting a plane including the first axis and the second axis. A first connection port for connecting the first flow path and the second flow path is formed corresponding to a position of either an antinode of the first standing wave or a node of a first standing wave.

The present application is based on, and claims priority from JP Application Serial Number 2021-210531, filed Dec. 24, 2021, the disclosure of which is hereby incorporated by reference herein in its entirety.

### BACKGROUND

### 1. Technical Field

The present disclosure relates to a fluid device, a particle removal apparatus including the fluid device, and a washing machine including the particle removal apparatus.

### 2. Related Arts

In related art, there has been known a fluid device that captures fine particles and the like contained in a fluid by an ultrasonic wave (see, for example, E. Benes and 10 others, “ULTRASONIC SEPARATION OF SUSPENDED PARTICLES”, February 2001, “Proceedings of the IEEE Ultrasonics Symposium”, p. 657 (Non-Patent Literature 1)).

In the fluid device disclosed in Non-Patent Literature 1, an ultrasonic wave transmitting element is disposed in a flow path through which a fluid flows, and a capturing unit that captures fine particles in the fluid by a standing wave is provided. In this fluid device, a flow path opening through which the fluid flows into the capturing unit has a small flow path width, and the flow path width is widened in the capturing unit. In addition, the flow path is branched into two from the capturing unit to form a first discharge port and a second discharge port, concentrated fine particles are discharged from the first discharge port, and a fluid having a reduced fine particle concentration is discharged from the second discharge port. A total of the flow path widths of the first discharge port and the second discharge port is the same as the flow path width of the capturing unit.

In the fluid device described in Non-Patent Literature 1, only two discharge ports which are the first discharge port and the second discharge port are provided, and thus a flow rate that can be processed by the fluid device is small. Therefore, when processing a large amount of water, for example, when separating fine fibers from washing water, it is difficult to perform processing with the fluid device in Non-patent Literature 1. It is also conceivable to provide a plurality of fluid devices described in Non-patent Literature 1, but in this case, it is necessary to provide a plurality of ultrasonic wave transmitting elements and a plurality of control circuits that control the ultrasonic wave transmitting elements, which leads to an increase in cost.

On the other hand, the number of ultrasonic wave transmitting elements can also be reduced by forming a standing wave having a plurality of nodes and antinodes in the capturing unit having a relatively wide flow path width, forming the first discharge port according to a position of each node of the standing wave, and forming the second discharge port according to a position of each antinode of the standing wave.

However, when a standing wave of an ultrasonic wave is formed in the fluid to capture the fine particles, it is necessary to form the standing wave in a Y direction orthogonal to an X direction by the ultrasonic wave transmitting element, with a flow direction of the fluid being the X direction. Therefore, since the nodes and antinodes are generated in the Y direction within an XY plane, the first discharge port and the second discharge port are arranged side by side in the Y direction, and thus a degree of freedom of alignment of the flow path is limited. In other words, it is necessary to set paths of the first discharge ports and the second discharge ports within the XY plane, which poses a problem of inevitably increasing the size of the fluid device.

### SUMMARY

A fluid device according to a first aspect of the present disclosure includes: a first flow path that extends along a first axis and through which a fluid flows in a positive side of the first axis; a first ultrasonic element configured to cause a first standing wave to be generated along a second axis orthogonal to the first axis in the first flow path; and a second flow path connected to the first flow path such that the fluid flows therethrough and extending along a third axis intersecting a plane including the first axis and the second axis. A first connection port for connecting the first flow path and the second flow path is formed corresponding to a position of either an antinode or a node of the first standing wave.

A particle removal apparatus according to a second aspect of the present disclosure includes: the fluid device according to the first aspect; an injection unit configured to cause the fluid to flow into the fluid device; a first discharge unit configured to discharge a first fluid that flows out from the first flow path; a second discharge unit configured to discharge a second fluid that flows out from the second flow path; a first flow path forming unit configured to connect the first flow path and the first discharge unit; and a second flow path forming unit configured to connect the second flow path and the second discharge unit.

A washing machine according to a third aspect of the present disclosure includes: the particle removal apparatus according to the second aspect; and a washing tub configured to wash clothes. The injection unit causes washing waste water to flow into the fluid device from the washing tub.

### BRIEF DESCRIPTION OF THE DRAWINGS

FIG. 1 is a schematic view showing a schematic configuration of a washing machine according to a first embodiment.

FIG. 2 is a cross-sectional view schematically showing a part of a fluid device according to the present embodiment.

FIG. 3 is a cross-sectional view of the fluid device taken along a line A-A in FIG. 2.

FIG. 4 is a cross-sectional view of the fluid device taken along a line B-B in FIG. 2.

FIG. 5 is a cross-sectional view of the fluid device taken along a line C-C in FIG. 2.

FIG. 6 is a cross-sectional view showing a schematic configuration of a fluid device in the related art.

FIG. 7 is a cross-sectional view showing a schematic configuration of the fluid device in the related art.

FIG. 8 is a cross-sectional view schematically showing a part of a fluid device according to a second embodiment.

FIG. 9 is a cross-sectional view of the fluid device taken along a line A-A in FIG. 8.

FIG. 10 is a cross-sectional view of the fluid device taken along a line B-B in FIG. 8.

FIG. 11 is a cross-sectional view showing a schematic configuration of a fluid device according to a third embodiment.

FIG. 12 is a cross-sectional view of the fluid device taken along a line A-A in FIG. 11.

FIG. 13 is a cross-sectional view of the fluid device taken along a line B-B in FIG. 11.

FIG. 14 is a cross-sectional view showing a schematic configuration of a fluid device according to a fourth embodiment.

FIG. 15 is a cross-sectional view showing a schematic configuration of a fluid device according to a second modification.

FIG. 16 is a cross-sectional view showing a schematic configuration of a fluid device according to a fourth modification.

### DESCRIPTION OF EXEMPLARY EMBODIMENTS

### First Embodiment

Hereinafter, a first embodiment will be described.

A fluid device in the present disclosure is a device that captures fine particles contained in a fluid by an ultrasonic wave and that separates the fluid into a fluid having a high fine particle concentration and a fluid having a low fine particle concentration, and can be suitably applied to a particle removal apparatus that removes the fine particles contained in the fluid. In the present embodiment, a washing machine including the particle removal apparatus will be described below as an example.

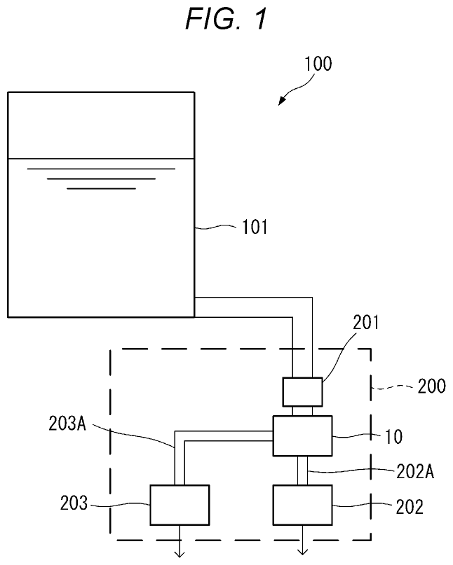

FIG. 1 is a schematic view showing a schematic configuration of a washing machine 100 according to the present embodiment.

The washing machine 100 includes a washing tub 101 that washes clothes and a particle removal apparatus 200. In the washing machine 100, washing waste water discharged from the washing tub 101 is introduced into the particle removal apparatus 200, fine particles contained in the washing waste water are removed by the particle removal apparatus 200, and the washing waste water is discharged.

The particle removal apparatus 200 includes an injection unit 201, a fluid device 10, a first discharge unit 202, and a second discharge unit 203.

The injection unit 201 is connected to the washing tub 101 by a drainage pipe, and the washing waste water flows into the injection unit 201. Then, the injection unit 201 introduces the washing waste water into the fluid device.

The fluid device 10 separates, from the washing waste water introduced from the injection unit 201, a first fluid having a concentrated particle concentration of fine particles such as microplastic and a second fluid having a diluted particle concentration of fine particles such as microplastic. A detailed configuration of the fluid device 10 will be described later.

The first discharge unit 202 processes the first fluid discharged from the fluid device 10. Specifically, the first fluid may be stored in a dedicated tank, or the first fluid may be dried to remove water, and only fine particles may be taken out as plastic recyclable waste.

The second discharge unit 203 discharges the second fluid discharged from the fluid device 10 to, for example, a sewage pipe for home use.

### Configuration of Fluid Device

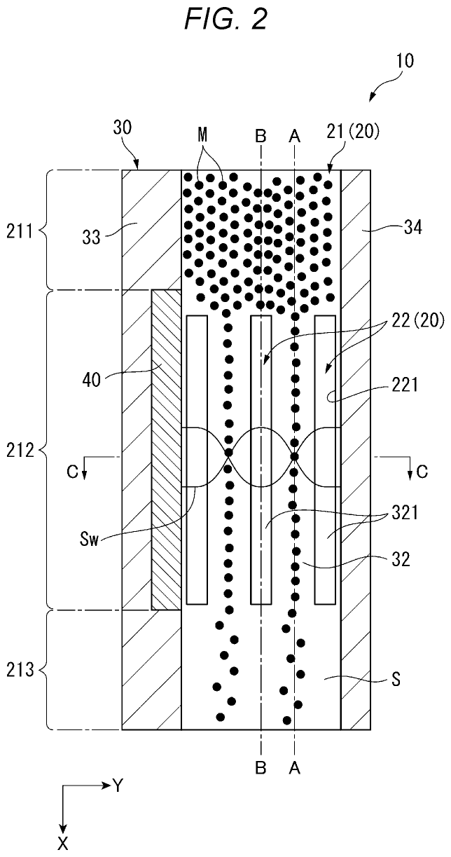

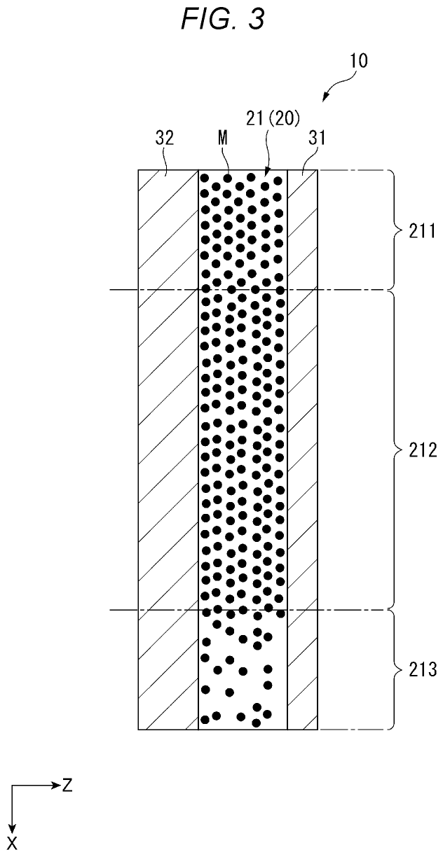

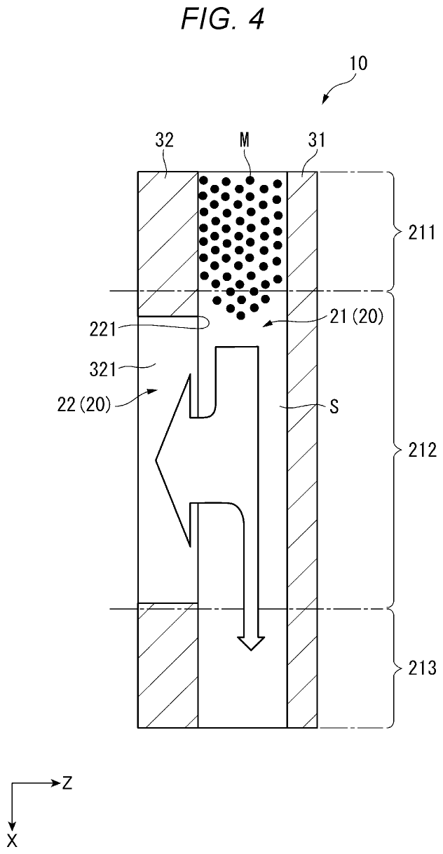

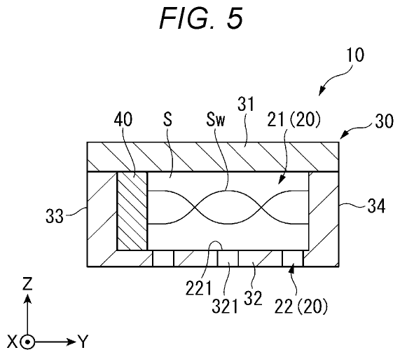

FIG. 2 is a cross-sectional view schematically showing a part of the fluid device 10 according to the present embodiment. FIG. 3 is a cross-sectional view of the fluid device 10 taken along a line A-A in FIG. 2. FIG. 4 is a cross-sectional view of the fluid device 10 taken along a line B-B in FIG. 2. FIG. 5 is a cross-sectional view of the fluid device 10 taken along a line C-C in FIG. 2.

The fluid device 10 includes a flow path substrate 30 with a flow path 20 formed therein, and a first ultrasonic element 40 provided at the flow path substrate 30. Here, in FIGS. 2 to 5, an X axis corresponds to a first axis in the present disclosure, and a fluid S flows in a positive side (+X) in the X axis. In the present embodiment, the positive side toward +X is a vertically downward direction.

In the following description, one axis orthogonal to the X axis is taken as a Y axis, and an axis orthogonal to the X axis and the Y axis is taken as a Z axis. Although details will be described later, the Y axis corresponds to a second direction according to the present disclosure, and is a direction in which a standing wave is formed by an ultrasonic wave transmitted by the first ultrasonic element 40.

The flow path substrate 30 is a substrate with the flow path 20 formed therein. The flow path substrate 30 can be formed by, for example, joining a pair of substrates having grooves corresponding to the flow path 20 to each other. The substrates constituting the flow path substrate 30 are not particularly limited, and for example, a glass substrate or a silicon substrate can be used.

The flow path 20 formed by the flow path substrate 30 includes a first flow path 21 extending along the X axis and second flow paths 22 branching from the first flow path 21 and extending in a third direction, the third direction extending in a direction intersecting the X axis and the Y axis. In the present embodiment, an example is shown in which the third direction is the Z direction orthogonal to an XY plane.

Specifically, as shown in FIG. 5, the first flow path 21 has a rectangular shape in a cross section in a YZ plane, and includes a first wall portion 31 constituting a wall portion of the flow path 20 on a +Z side of the Z axis, a second wall portion 32 constituting a wall portion of the flow path 20 on a −Z side of the Z axis, a third wall portion 33 constituting a wall portion of the flow path 20 on a −Y side of the Y axis, and a fourth wall portion 34 constituting a wall portion of the flow path 20 on a +Y side of the Y axis.

Here, as shown in FIG. 2, a fluid inflow part 211, a capturing unit 212, and a first flow path outlet 213 are provided at the first flow path 21 along the X axis. The fluid inflow part 211, the capturing unit 212, and the first flow path outlet 213 have the same or substantially the same flow path width along the Y axis and the Z axis. Accordingly, turbulent flow is less likely to occur in washing waste water (hereinafter, referred to as a fluid S) that flows through the first flow path 21, and a movement of fine particles M due to the turbulent flow is prevented.

The fluid inflow part 211 in the first flow path 21 is introduced with the fluid S from the injection unit 201 disposed upstream (on a −X side), and causes the fluid S to flow into the capturing unit 212.

The capturing unit 212 is a part that causes an ultrasonic wave to be generated in the fluid S introduced from the fluid inflow part 211 to capture the fine particles M. In the present embodiment, the first ultrasonic element 40 is disposed at the third wall portion 33, and an ultrasonic wave is transmitted, from the first ultrasonic element 40, toward the +Y side to generate a standing wave SW (a first standing wave) of a second-order mode along the Y axis.

The first ultrasonic element 40 is not particularly limited as long as the first ultrasonic element 40 causes the standing wave SW to be generated by the ultrasonic wave along the Y axis. For example, the first ultrasonic element 40 may be a thin-film ultrasonic element in which a plurality of ultrasonic transducers with piezoelectric elements disposed in a thin-film vibrating portion are arranged in an array, and in which each vibrating portion is vibrated by applying a voltage to the piezoelectric element to transmit an ultrasonic wave. Alternatively, the first ultrasonic element 40 may be a bulk-type ultrasonic element that vibrates a piezoelectric body itself by applying a voltage to the piezoelectric body. In addition, a disposition position of the first ultrasonic element 40 is not limited to the third wall portion 33, and may be, for example, the fourth wall portion 34 or the first wall portion 31 as long as the standing wave SW can be generated along the Y axis.

In the capturing unit 212, a plurality of branch holes 321 are formed in the second wall portion 32. These branch holes 321 are, for example, through holes penetrating in a wall thickness direction of the second wall portion 32, and the branch holes 321 form the second flow paths 22 through which the fluid S can flow between the first flow path 21 and the second flow paths 22. An opening portion of the branch hole 321 in the second wall portion 32 is a connection portion between the first flow path 21 and the second flow path 22, and is hereinafter referred to as a first connection port 221.

More specifically, these first connection ports 221 are formed at positions of antinodes of the standing wave SW formed by the ultrasonic wave transmitted from the first ultrasonic element 40. An opening width of the first connection port 221 along the Y axis is a width less than a half wavelength of the ultrasonic wave, and more preferably a width equal to or less than ¼ wavelength.

An end portion of each first connection port 221 on the −X side is positioned on the +X side with respect to an end portion of the first ultrasonic element 40 on the −X side.

A position of the end portion of the first connection port 221 on the +X side is not particularly limited, and the end portion of the first connection port 221 on the +X side is preferably positioned on the same position as the end portion of the first ultrasonic element 40 on the +X side, or on the −X side with respect to the end portion of the first ultrasonic element 40 on the +X side.

The first flow path outlet 213 is a flow path through which the fluid S flows from the capturing unit 212 to the +X side, and is connected to the first discharge unit 202 through a first flow path forming unit 202A as shown in FIG. 1. In the present embodiment, even when the standing wave SW of high-order is generated, it is only necessary to form one first flow path outlet 213, and thus a flow path configuration of the first flow path forming unit 202A can be simplified.

As described above, the second flow paths 22 are branched from the capturing unit 212 on the first flow path 21, that is, are connected to the first flow path 21 through the first connection ports 221 such that the fluid S can flow therethrough, and extend in an extending direction of the branch hole 321, that is, a −Z direction.

In the present embodiment, since the first connection port 221 is formed at a position of each antinode of the standing wave SW as described above, the fluid S that flows into the position of each antinode flows into the second flow paths 22 in the capturing unit 212.

As shown in FIG. 1, the second flow paths 22 are connected to the second discharge unit 203 through a second flow path forming unit 203A. Here, since the second flow paths 22 are drawn out in a direction different from that of the first flow path outlet 213 on the first flow path 21, it is not necessary to route the first flow path forming unit 202A and the second flow path forming unit 203A in the same plane, and thus it is possible to simplify the flow path configurations.

A specific illustration of the second flow path forming unit 203A is omitted. Alternatively, the branch hole 321 extending along the Z direction may be extended as it is and connected to the second discharge unit 203, or a flow path configuration extending from the branch hole 321 in another direction may be provided. In addition, the plurality of second flow paths 22 may be individually connected to the second discharge unit 203, or the plurality of second flow paths 22 may be joined and then connected to the second discharge unit 203.

### Separation of Fine Particles M by Fluid Device 10

Next, the separation of the fine particles M by the fluid device 10 as described above will be described in comparison with a configuration in the related art.

First, the separation of the fine particles M in the fluid device according to the present embodiment will be described.

In the fluid device 10 according to the present embodiment, when the first ultrasonic element 40 is driven to transmit an ultrasonic wave, the standing wave SW is generated in the fluid S in the capturing unit 212. Due to a pressure gradient of the standing wave SW, the fine particles M contained in the fluid S are moved to positions of nodes of the standing wave SW, that is, are captured at the positions of the nodes, and flow into the first flow path outlet 213 on the +X side by the flow of the fluid S.

On the other hand, at positions of the antinodes of the standing wave SW, the fine particles M are moved to the positions of the nodes, whereby a concentration of the fine particles M decreases. Most of the fluid S flowing through the antinodes of the standing wave SW branches and flows into the second flow paths 22.

Accordingly, a concentrated fluid (a first fluid) having a high concentration of the fine particles M flows through the first flow path outlet 213 of the first flow path 21, and a diluted fluid (a second fluid) having a low concentration of the fine particles M flows through the second flow paths 22.

Here, in the present embodiment, the end portion of the first connection port 221 on the −X side is positioned on the +X side with respect to the end portion of the first ultrasonic element 40 on the −X side. Accordingly, the fine particles M that have flowed from the fluid inflow part 211 into the capturing unit 212 are prevented from flowing into the second flow paths 22 without being moved by the pressure of the standing wave SW.

In the present embodiment, a distance from the end portion of the first connection port 221 on the −X side to the end portion of the first ultrasonic element 40 on the −X side may be equal to or greater than a distance by which the fine particles M positioned at the antinode of the standing wave SW are moved to the position of the node. That is, the distance may be set according to a sound pressure of the ultrasonic wave output from the first ultrasonic element 40, a flow velocity of the fluid S introduced from the fluid inflow part 211, and a particle size and mass of the fine particles M to be captured by the standing wave SW.

An end portion of the first connection port 221 on +X side is positioned on the same side as an end portion of the first ultrasonic element 40 on the +X side or on the −X side with respect to the end portion of the first ultrasonic element 40 on the +X side.

The more the end portion of the first connection port 221 on the +X side is positioned on the +X side, the more the diluted fluid can flow into the second flow paths 22. It is noted that, on the +X side of a position where the standing wave SW is formed, the fine particles M captured at the nodes of the standing wave SW start to be dispersed again in the Y direction. On the other hand, with the configuration described above, it is possible to prevent the flowing of the fine particles M into the second flow path.

Since the ultrasonic wave output from the first ultrasonic element 40 is weak on both ±X end sides and becomes stronger toward a center portion in the X direction, a capturing force of the fine particles M due to the pressure gradient of the standing wave SW becomes weak on both the ±X end sides. Therefore, by providing, on the −X side with respect to the end portion of the first ultrasonic element 40 on the +X side, the end portion of the first connection port 221 on the +X side, it is possible to further prevent the flowing of the fine particles M into the second flow path.

Further, in the present embodiment, a width of the first connection port 221 in the Y direction is less than a half wavelength of the ultrasonic wave, and more preferably equal to or less than ¼ wavelength. Accordingly, the flowing of the fine particles M moved to the position of the node of the standing wave SW into the second flow paths 22 is prevented.

In the present embodiment, since the second flow paths 22 are connected corresponding to the positions of the antinodes of the standing wave SW, the fine particles M captured at the position of the node of the standing wave SW are subjected to a stress caused by the fluid S flowing through the second flow paths 22 on the +Y side of the node and a stress caused by the fluid S flowing through the second flow paths 22 on the −Y side of the node, and both stresses are balanced with each other. Therefore, it is possible to prevent the inconvenience that the fine particles M captured at the position of the node flow into the second flow paths 22.

In the present embodiment as described above, an excellent effect is achieved in terms of the separation of the fine particles M by processing a large amount of fluid and the simplification of the flow path configuration, as compared with a fluid device in the related art. This will be described in comparison with a configuration in the related art.

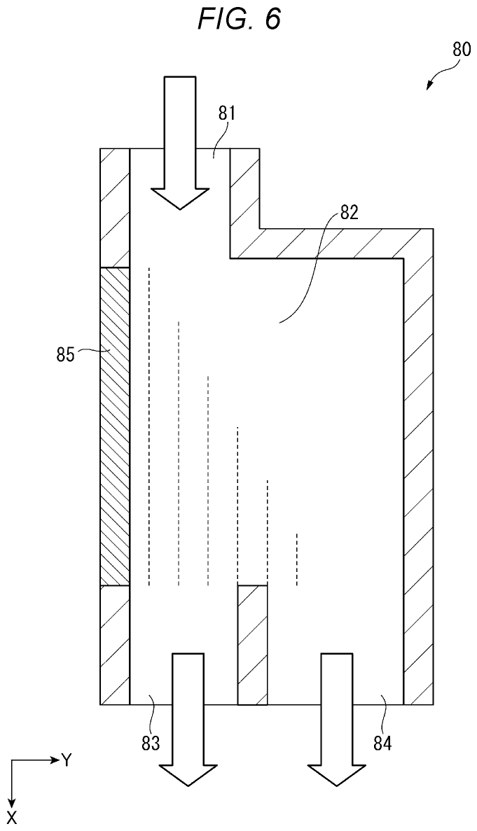

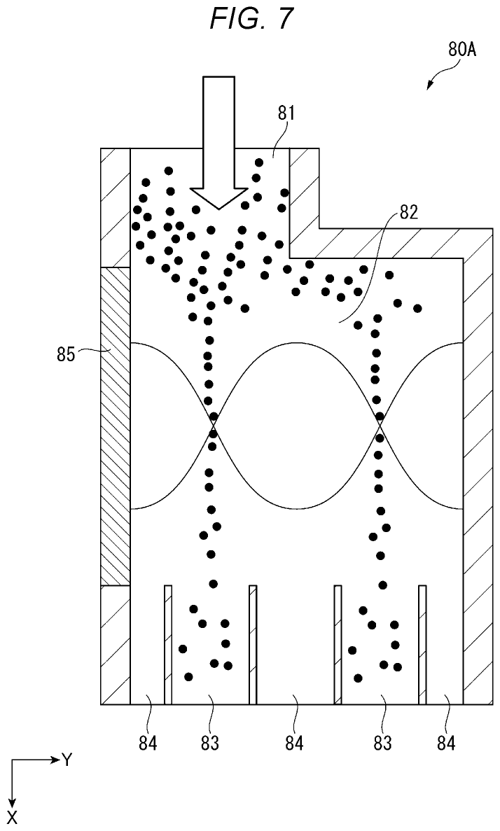

FIGS. 6 and 7 are cross-sectional views showing a schematic configuration of a fluid device in the related art.

As shown in FIG. 6, a fluid device 80 in the related art includes a fluid inflow part 81, a capturing unit 82, a concentrated fluid outlet 83, a diluted fluid outlet 84, and an ultrasonic element 85. The fluid inflow part 81 is a unit that introduces a fluid into the capturing unit 82, and the capturing unit 82 has a larger flow path width along the Y axis than the fluid inflow part 81. In the capturing unit 82, an ultrasonic wave is transmitted from the ultrasonic element 85 to the fluid S to generate a standing wave of a high-order mode, thereby capturing the fine particles at the position of the node as in the present embodiment.

Here, in the fluid device 80 in the related art as shown in FIG. 6, the fluid inflow part 81 is connected to end portions of the capturing unit 82 on the −X side and −Y side, the concentrated fluid outlet 83 is provided on the +X side and −Y side of the capturing unit 82, and the diluted fluid outlet 84 is provided on the +X side and +Y side of the capturing unit 82.

In FIG. 6, the position of the node of the standing wave is indicated by a broken line, and the number of fine particles M captured at the node is indicated by a length of the broken line. As shown in FIG. 6, in the fluid device 80, the fine particles are captured at the nodes of the standing wave while the fluid flowing into the capturing unit 82 from the fluid inflow part 81 provided on the −Y side diffuses and flows toward the +Y side. Therefore, more fine particles are captured at the node on the −Y side, and the concentration of the fine particles decreases toward the +Y side. By providing the diluted fluid outlet 84 on the +Y side and providing the concentrated fluid outlet 83 on the −Y side, the concentrated fluid and the diluted fluid can be separated.

However, since a flow path width of the capturing unit 82 along the Y direction is larger than that of the fluid inflow part 81, a vortex (turbulent flow) is generated in the fluid S in the vicinity of a connection portion between the fluid inflow part 81 and the capturing unit 82. Therefore, the fine particles M go around to the +Y side, and the number of the fine particles M flowing out from the diluted fluid outlet 84 increases.

On the other hand, in the present embodiment, the fluid inflow part 211, the capturing unit 212, and the first flow path outlet 213 have the same flow path width in the Y direction. Therefore, the generation of the vortex as described above is prevented, and the movement of the fine particles M due to the turbulent flow is prevented.

In the fluid device 80 as shown in FIG. 6, since only one concentrated fluid outlet 83 and only one diluted fluid outlet 84 are formed, the fluid device 80 is not suitable for processing a large amount of fluid such as washing waste water. That is, in the fluid device 80 shown in FIG. 6, it is necessary to capture the fine particles in the fluid at any node of the standing wave, between the fluid inflow part 81 positioned on the −Y side and the diluted fluid outlet 84 on the +Y side. When a width of the concentrated fluid outlet 83 in the Y direction is enlarged and a width of the diluted fluid outlet 84 in the Y direction is reduced in order to reduce the number of the fine particles flowing through the diluted fluid outlet 84, the concentration of the concentrated fluid flowing from the concentrated fluid outlet 83 decreases. Therefore, when reducing the number of the fine particles flowing into the diluted fluid outlet 84, it is necessary to reduce the overall flow path width and reduce the flow rate, and thus a large amount of fluid cannot be processed.

It is also possible to process a large amount of water by providing a plurality of fluid devices 80, but in this case, as many ultrasonic elements 85 as the number of fluid devices 80 and control circuits that control the ultrasonic elements 85 are required, and a large amount of electric power is required to drive a large number of ultrasonic elements 85, which results in an increase in cost.

On the other hand, in a fluid device 80A shown in FIG. 7, the standing wave SW of a high-order mode is generated in the capturing unit 82, the concentrated fluid outlets 83 are formed on the +X side of the capturing unit 82 and corresponding to the positions of the nodes of the standing wave SW, respectively, and the diluted fluid outlets 84 are formed on the +X side of the capturing unit 82 and corresponding to the positions of the antinodes of the standing wave SW, respectively.

In such a fluid device 80A, as compared with the fluid device 80 shown in FIG. 6, the fine particles M can be separated from a larger amount of fluid S, the number of the ultrasonic elements 85 is small, and thus the cost can be reduced. In FIG. 7, the number of concentrated fluid outlets 83 and diluted fluid outlets 84 are reduced for the sake of simplicity. By using the standing wave of higher-order and increasing the number of concentrated fluid outlets 83 and diluted fluid outlets 84, the flow rate of the fluid that can be processed is also increased.

However, in the configuration as shown in FIG. 7, since the concentrated fluid outlets 83 and the diluted fluid outlets 84 are alternately arranged along the Y direction, it is necessary to route and form, in the same plane, a flow path configuration that connects the plurality of concentrated fluid outlets 83 and the first discharge unit 202 and a flow path configuration that connects the plurality of diluted fluid outlets 84 and the second discharge unit 203, and thus the flow path configuration becomes complicated. In order to process a large amount of water, there is a problem that the more the number of the concentrated fluid outlets 83 and diluted fluid outlets 84 is increased, the more complicated the flow path configuration is.

On the other hand, in the present embodiment, as described above, the first flow path outlet 213 through which the concentrated fluid is discharged is drawn out to the +X side in the XY plane, and the second flow paths 22 through which the diluted fluid is discharged are drawn out to the −Z side of the Z axis intersecting (orthogonal to) the XY plane. Therefore, the flow path configuration from the first flow path outlet 213 to the first discharge unit 202 and the flow path configuration from the second flow paths 22 to the second discharge unit 203 can be formed in different planes, respectively, a degree of freedom of the flow path design is increased, and the flow path configuration can be simplified. That is, the fluid device 10 shown in FIGS. 2 to 5 is an example of forming the standing wave SW of a second-order mode, and further, in the case of forming the standing wave SW of a high-order mode, the second flow paths 22 are connected to the positions of the antinodes, respectively. Even in such a case, in the present embodiment, since the first flow path outlet 213 and the second flow paths 22 are drawn out in different directions, it is possible to prevent complication of the flow path configuration. In addition, even when the standing wave SW of high-order is generated, the number of the first flow path outlets 213 is one, and it is not necessary to form a large number of concentrated fluid outlets 83 as shown in FIG. 7, and thus it is possible to further simplify the flow path configuration.

Functions and Effects according to Present Embodiment

The fluid device 10 according to the present embodiment includes the first flow path 21, the first ultrasonic element 40, and the second flow paths 22. The first flow path 21 extends along the X axis (the first axis), and causes the fluid S to flow toward the +X side. The first ultrasonic element 40 causes the standing wave SW (the first standing wave) to be generated along the Y axis (the second axis) orthogonal to the X axis in the first flow path 21. The second flow paths 22 are connected to the first flow path 21 such that the fluid S can flow therethrough, and extend along the Z axis (third axis) intersecting the plane including the X axis and the Y axis. The first connection port 221 that connects the first flow path 21 and the second flow path 22 is formed at the position corresponding to the antinode of the first standing wave SW.

Accordingly, the fine particles M in the fluid S are moved from the antinode toward the node of the standing wave SW by the pressure gradient of the standing wave SW, and the fine particles M are captured at the node. Therefore, at the position of the node of the standing wave SW, the concentrated fluid having a high concentration of the fine particles M flows to the first flow path 21 toward the +X side, and is discharged from the first flow path outlet 213. On the other hand, at the position of the antinode of the standing wave SW, the diluted fluid having a low concentration of the fine particles flows, and the diluted fluid is discharged to the −Z side from the second flow paths 22 provided at the position corresponding to the antinode.

That is, the second flow paths 22 are formed in a plane intersecting the XY plane in which the first flow path 21 is formed. Therefore, as compared with the case in which the first flow path 21 and the second flow paths 22 are formed in the same plane, a configuration of the first flow path forming unit 202A that connects between the first flow path 21 and the first discharge unit 202 and a configuration of the second flow path forming unit 203A that connects between the second flow paths 22 and the second discharge unit 203 can be simplified. That is, when the first flow path 21 and the second flow paths 22 are formed in the same plane, it is necessary to route the first flow path forming unit 202A and the second flow path forming unit 203A in the plane, and thus the flow path configuration becomes complicated. For example, the flow path is implemented by three-dimensionally intersecting the first flow path forming unit 202A and the second flow path forming unit 203A. On the other hand, in the present embodiment, since the second flow paths 22 are drawn out in the direction intersecting the XY plane from which the first flow path 21 is drawn out, the flow path configuration is not complicated, a configuration such as merging of the plurality of second flow paths 22 can be easily implemented, and thus the configuration can be simplified. Therefore, it is possible to reduce the size of the fluid device 10 and the particle removal apparatus 200, and to reduce the size of the washing machine 100.

In the present embodiment, a length of the first connection port 221 along the X-axis is smaller than a half wavelength of the ultrasonic wave that forms the standing wave SW.

Accordingly, it is possible to prevent the fine particles M captured at the position of the node of the standing wave SW from flowing into the second flow paths 22 provided at the positions corresponding to the antinodes of the standing wave SW.

In the fluid device 10 according to the present embodiment, the end portion of the first connection port 221 on the −X side is positioned on the +X side with respect to the end portion of the first ultrasonic element 40 on the −X side.

Accordingly, the fine particles M before being captured by the node of the standing wave SW, that is, the fine particles M that have just flowed into the capturing unit 212 from the fluid inflow part 211, can be prevented from flowing into the second flow paths 22, and the fine particles M can flow in an appropriate direction.

In the present embodiment, the X axis is parallel to a vertical direction, and the +X side is vertically downward.

Accordingly, gravity acts on the fine particles M on the +X side. For example, when a direction of gravity is the Z direction, gravity in a direction toward the antinode of the standing wave SW acts on the fine particles M captured at the node of the standing wave SW, and thus the number of fine particles M flowing into the second flow paths 22 increases. On the other hand, in the present embodiment, the fine particles M can flow toward the first flow path outlet 213 on the +X side by a stress caused by the flow of the fluid S and gravity, and the flowing of the fine particles M into the second flow paths 22 can be prevented.

The particle removal apparatus 200 according to the present embodiment includes: the injection unit 201 that causes the fluid S to flow into the fluid device 10, the first discharge unit 202 that discharges the concentrated fluid (the first fluid) that flows out from the first flow path outlet 213 on the first flow path 21, the second discharge unit 203 that discharges the diluted fluid (the second fluid) that flows out from the second flow paths 22, the first flow path forming unit 202A that connects the first flow path 21 and the first discharge unit 202, and the second flow path forming unit 203A that connects the second flow paths 22 and the second discharge unit 203.

In the fluid device 10 according to the present embodiment, the first flow path 21 and the second flow paths 22 are drawn out in different surface directions. Therefore, the first flow path forming unit 202A and the second flow path forming unit 203A can be independently formed in different planes, and the flow path configurations of the first flow path forming unit 202A and the second flow path forming unit 203A can be simplified.

The washing machine 100 according to the present embodiment includes the particle removal apparatus 200 as described above and the washing tub 101 that washes clothes, and the injection unit 201 causes washing waste water from the washing tub 101 to flow into the fluid device 10.

Accordingly, minute microplastic fibers contained in the washing waste water can be branched into the second flow paths 22 by the fluid device. Therefore, it is possible to remove microplastic fibers, which cause marine contamination, from the washing waste water.

### Second Embodiment

Next, a second embodiment will be described.

In the first embodiment, an example has been shown in which the second flow paths 22 are connected to the first flow path 21 at positions of antinodes of the standing wave SW. On the other hand, in the present embodiment, positions at which the second flow paths 22 are connected to the first flow path 21 are different from those in the first embodiment.

In the following description, described items are denoted by the same reference numerals, and the description thereof is omitted or simplified.

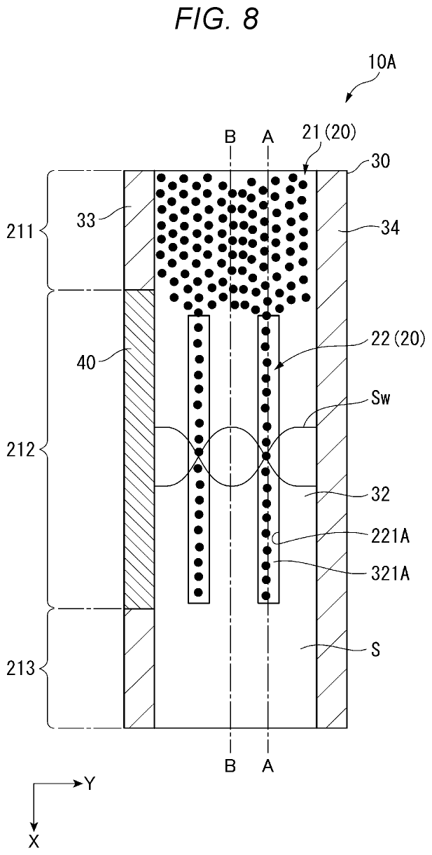

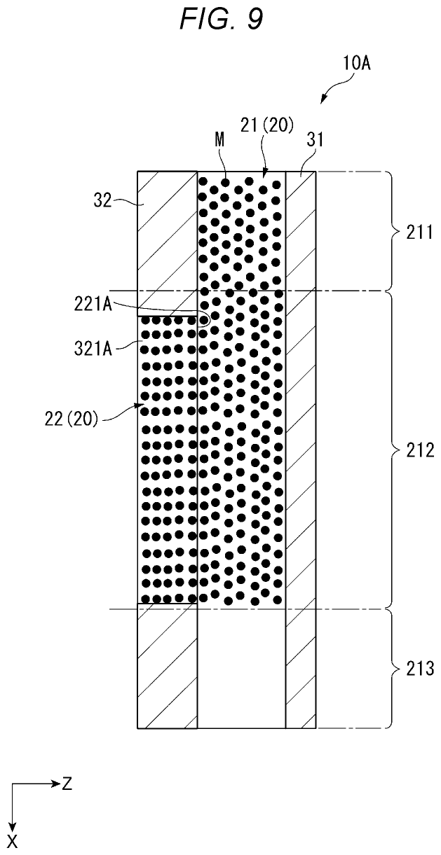

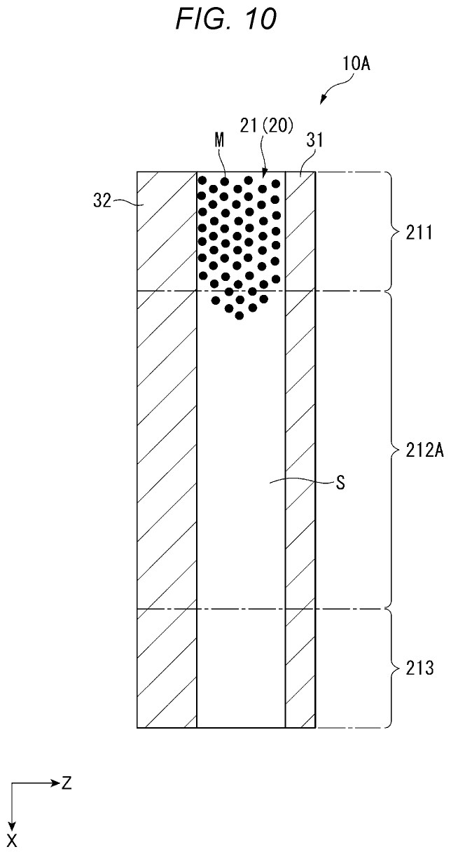

FIG. 8 is a cross-sectional view schematically showing a part of a fluid device 10A according to the second embodiment. FIG. 9 is a cross-sectional view of the fluid device 10A taken along a line A-A in FIG. 8. FIG. 10 is a cross-sectional view of the fluid device 10A taken along a line B-B in FIG. 8.

In the present embodiment, similarly to the first embodiment, the fluid inflow part 211, a capturing unit 212A in which the first ultrasonic element 40 is provided, and the first flow path outlet 213 are provided at the first flow path 21, and the second flow paths 22 extending in a direction intersecting an XY plane are connected in the capturing unit 212A.

Here, in the present embodiment, the second flow paths 22 are connected to the first flow path 21 at positions of nodes of the standing wave SW formed by the first ultrasonic element 40 in the capturing unit 212A. That is, in the second wall portion 32 constituting the flow path 20, branch holes 321A are formed at positions of the nodes of the standing wave SW, and the branch holes 321A form the second flow paths 22.

In the present embodiment, an end portion of the first connection port 221A on a −X side, which is an opening end surface of the branch hole 321A in the second wall portion 32, may coincide with an end portion of the first ultrasonic element 40 on the −X side. That is, in the present embodiment, the fine particles M in the fluid S are captured at the nodes of the standing wave SW and flow along the second flow paths 22. Therefore, when the end portion of the first connection port 221A on the −X side coincides with the end portion of the first ultrasonic element 40 on the −X side, the fine particles M that have just been introduced from the fluid inflow part 211 to the capturing unit 212A can flow into the second flow paths 22.

Further, in the first embodiment, the +X side of the X axis is a vertically downward direction (a direction of gravity). Alternatively, in the present embodiment, a −Z side may be the vertically downward direction. In this case, the fine particles M in the fluid S can flow into the second flow paths 22 by gravity in addition to a stress caused by the flow of the fluid S.

Functions and Effects according to Present Embodiment

The present embodiment can achieve the same functions and effects as those according to the first embodiment.

That is, also in the present embodiment, the second flow paths 22 extend in the Z direction intersecting the XY plane, with the X axis being a flow direction of the fluid S in the first flow path 21 and the Y axis being a formation direction of the standing wave SW.

Therefore, flow path configurations of the first flow path forming unit 202A and the second flow path forming unit 203A can be simplified, and thus the fluid device 10 and the particle removal apparatus 200 can be miniaturized.

In the present embodiment, the Z axis is parallel to a vertical direction, and the −Z side is a vertically downward direction.

Accordingly, the fine particles M are guided to the second flow paths 22 by gravity in addition to the stress caused by the flow of the fluid S. In the present embodiment, a first fluid discharged from the first flow path outlet 213 in the first flow path 21 is a diluted fluid having a low concentration of the fine particles M, and a second fluid discharged from the second flow path 22 is a concentrated fluid having a high concentration of the fine particles M. According to the above configuration, the number of the fine particles M flowing into the second flow path increases, and thus the particle concentration of the concentrated fluid can be increased.

### Third Embodiment

Next, a third embodiment will be described.

In the fluid devices 10 and 10A according to the first embodiment and the second embodiment, a flow path width of the fluid inflow part 211 in a Y direction is the same as a flow path width of the capturing units 212 and 212A in the Y direction.

On the other hand, the third embodiment is different from the first embodiment and the second embodiment in that a fluid inflow part and a capturing unit have different flow path widths.

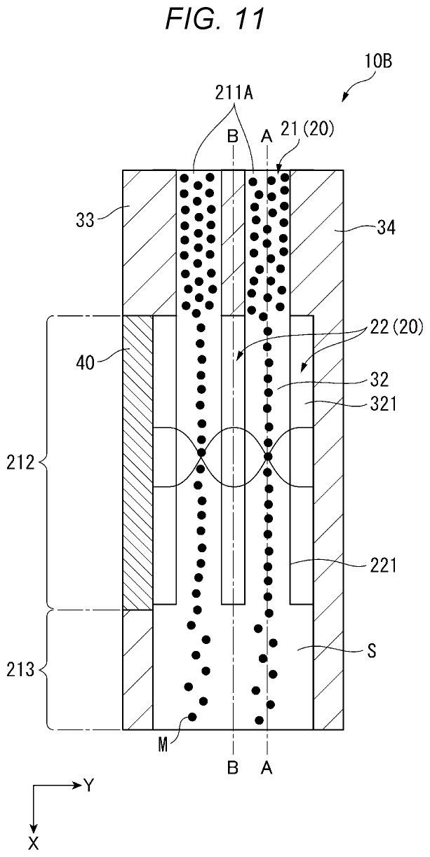

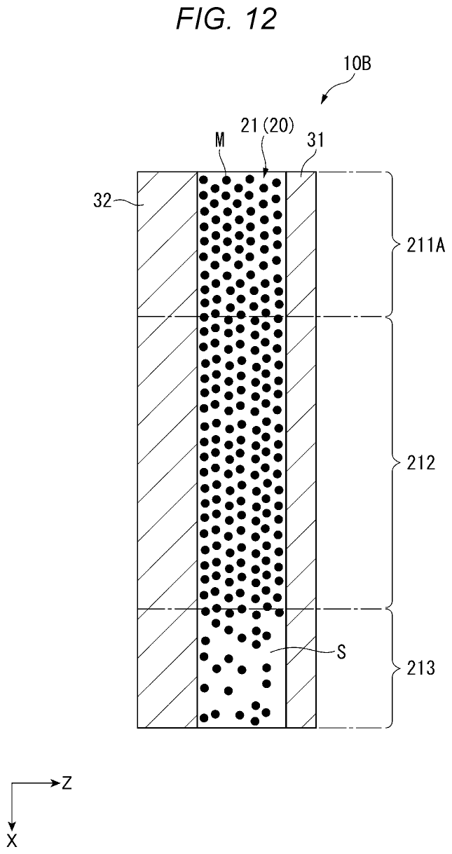

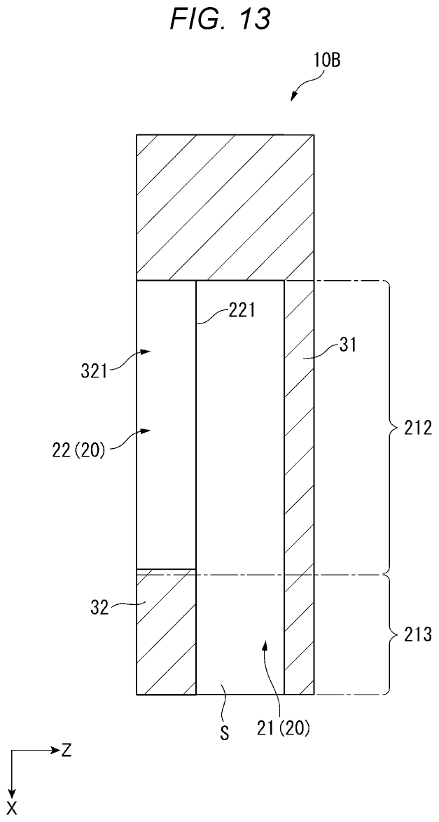

FIG. 11 is a cross-sectional view showing a schematic configuration of a fluid device 10B according to the third embodiment. FIG. 12 is a cross-sectional view of the fluid device 10B taken along a line A-A in FIG. 11. FIG. 13 is a cross-sectional view of the fluid device 10B taken along a line B-B in FIG. 11.

As shown in FIG. 11, the fluidic device 10B according to the present embodiment includes a plurality of fluid inflow parts 211A arranged in the Y direction, the capturing unit 212 to which these fluid inflow parts 211A are connected, and the first flow path outlet 213.

That is, in the present embodiment, a flow path width of the fluid inflow part 211A along the Y direction is narrow with respect to that of the capturing unit 212, and each fluid inflow part 211A is connected to a position corresponding to a node of the standing wave SW formed by the capturing unit 212.

Therefore, the fine particles M in the fluid S introduced from the fluid inflow parts 211 flows into positions of the nodes of the standing wave SW, and are immediately captured at the positions of the nodes due to a pressure gradient. Therefore, as compared with the case in which the fluid S is also introduced from the fluid inflow part 211 to a position of an antinode of the standing wave SW, the number of fine particles M flowing through the position of the antinode can be reduced. Therefore, the number of the fine particles M flowing through the second flow paths 22 can be reduced.

In the present embodiment, since the fluid S is introduced from the fluid inflow parts 211A to the positions of the nodes of the standing wave SW, an end portion of the first connection port 221 on the −X side may be at the same position as an end portion of the first ultrasonic element 40 on the −X side.

In FIGS. 11 to 13, a configuration example is shown in which the second flow paths 22 are provided at the positions of the antinodes. Alternatively, the second flow paths 22 may be provided at the positions of the nodes as in the second embodiment.

Functions and Effects according to Present Embodiment

In the fluid device 10 according to the present embodiment, the first flow path 21 includes the plurality of fluid inflow parts 211A into which the fluid flows, and the capturing unit 212 to which the plurality of fluid inflow parts 211A are connected and in which the first ultrasonic element 40 is disposed, and the plurality of fluid inflow parts 211A are connected to the capturing unit 212 in a manner of corresponding to the positions of the nodes of the standing wave SW.

Accordingly, the fine particles M in the fluid S flowing from the fluid inflow parts 211A are captured at the positions of the nodes of the standing wave SW immediately after flowing into the capturing unit 212, and the concentrated fluid having a high concentration of the fine particles M and the diluted fluid having a low concentration of the fine particles can be separated with higher accuracy.

### Fourth Embodiment

Next, a fourth embodiment will be described.

In the first embodiment, the second embodiment, and the third embodiment, an example is shown in which the fine particles M are captured by the standing wave SW generated by one capturing unit 212 to separate a concentrated fluid and a diluted fluid. Alternatively, a configuration may be adopted in which a plurality of capturing units are connected in an X direction to further increase a particle concentration.

In the fourth embodiment, a configuration example will be described in which particles are concentrated by a plurality of capturing units.

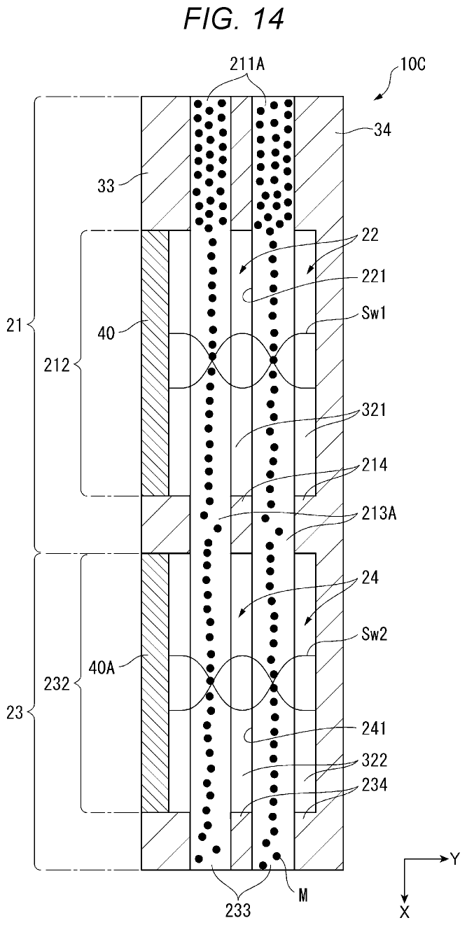

FIG. 14 is a cross-sectional view showing a schematic configuration of a fluid device 10C according to the fourth embodiment.

In the present embodiment, the flow path 20 includes the first flow path 21, the second flow paths 22, a third flow path 23, and fourth flow paths 24.

Similarly to the third embodiment, a plurality of fluid inflow parts 211A and the capturing unit 212 (in the present embodiment, in order to distinguish from a second capturing unit 232 to be described later, referred to as a first capturing unit 212) are provided at the first flow path 21. The plurality of fluid inflow parts 211A are connected to the first capturing unit 212 at positions of nodes of a first standing wave SW1 formed by the first capturing unit 212.

In the present embodiment, first flow path outlets 213A are formed according to the positions of the nodes of the first standing wave SW1 formed by the first capturing unit 212. Therefore, wall portions 214 are formed on a +X side of connection positions of the second flow paths 22 in the first capturing unit 212, and the fluid S flowing into the +X side at a position of an antinode of the first standing wave SW1 is guided to the second flow paths 22 by the wall portions 214.

The third flow path 23 is connected to the +X side of the first flow path 21, and similarly to the first flow path 21, is formed in a rectangular cross-sectional shape surrounded by the wall portions 31, 32, 33, and 34, and the fluid S flowing from the first flow path 21 to the +X side is introduced into the third flow path 23. That is, in the present embodiment, the first flow path outlets 213A in the first flow path 21 serve as a fluid inflow part on the third flow path 23.

The second capturing unit 232 connected to the first flow path outlets 213A and third flow path outlets 233 connected to the +X side of the second capturing unit 232 are provided at the third flow path 23.

In the second capturing unit 232, for example, a second ultrasonic element 40A is disposed at the third wall portion 33 on the −Y side, and a second standing wave SW2 is formed along the Y axis in the second capturing unit 232 by the second ultrasonic element 40A. An order of the second standing wave SW2 may be the same as or different from that of the first standing wave SW1. In the example shown in FIG. 14, the order of the second standing wave SW2 and the order of the first standing wave SW1 are the same.

In the second capturing unit 232, similarly to the first capturing unit 212 on the first flow path 21, second branch holes 322 are formed corresponding to positions of antinodes of the second standing wave SW2, and the second branch holes 322 form the fourth flow paths 24 extending in a direction intersecting an XY plane (for example, to a −Z side).

A second connection port 241 (an opening end of the second branch hole 322 facing the third flow path 23), which is a connection portion between the third flow path 23 and the fourth flow path 24, is the same as the first connection port 221 in the third embodiment, and an end portion of the second connection port 241 on the −X side may be provided at the same position as an end portion of the second ultrasonic element 40A on the −X side.

A width of the second connection port 241 in a Y direction is less than a half wavelength of the second standing wave, and more preferably equal to or less than ¼ wavelength.

The third flow path outlets 233 are connected to the X +side of the second capturing unit 232 at positions corresponding to the nodes of the second standing wave SW2, and the fine particles M captured at the nodes of the second standing wave SW2 are discharged. Since the wall portion 234 is provided between the third flow path outlets, a diluted fluid can be suitably guided to the fourth flow paths 24, similarly to the first flow path outlets 213A.

In the present embodiment, the third flow path outlets 233 are connected to the first discharge unit 202, and the second flow paths 22 and the fourth flow paths 24 are connected to the second discharge unit 203. At this time, the second flow paths 22 and the fourth flow paths 24 are drawn out in a Z direction intersecting an XY plane, and are in a plane different from a drawing direction of the third flow path outlets 233, and thus the flow path configuration can be simplified.

Functions and Effects according to Present Embodiment

The fluid device 10C according to the present embodiment includes the third flow path 23 disposed on the +X side of the first flow path 21, the second ultrasonic element 40A that causes the second standing wave SW2 to be generated along the Y axis in the third flow path 23, and the fourth flow paths 24 branching from the third flow path 23 in the Z direction at the positions corresponding to the antinodes of the second standing wave SW2.

Accordingly, the concentrated fluid introduced from the first flow path 21 to the third flow path 23 can be separated into a concentrated fluid having a higher concentration of fine particles and a diluted fluid.

Even in this case, since the second flow paths 22 and the fourth flow paths 24 can be drawn out in the direction intersecting the X axis where the fluid is discharged from the third flow path 23, the flow path configuration of each flow path can be simplified.

In the present embodiment, the third flow path 23 is connected to a portion downstream of the first flow path 21, and a similar configuration may be further connected to a portion downstream of the third flow path 23. Accordingly, the removal of the fine particles (that is, the separation between a fluid having a large content of the fine particles and a fluid having a small content of the fine particles) can be further promoted.

### Modifications

The present disclosure is not limited to the embodiments described above, and configurations obtained through modifications, alterations, and appropriate combinations of the embodiments within a scope of being capable of achieving the object of the present disclosure are included in the present disclosure.

### First Modification

In FIGS. 2 and 3, an example has been shown in which a flow path width of the first flow path outlet 213 in the Y direction and a flow path width of the capturing unit 212 in the Y direction are the same, but the present disclosure is not limited thereto.

For example, the first flow path outlets 213A shown in the fourth embodiment may be formed instead of the first flow path outlet 213. That is, the first flow path outlets 213A may be formed, on the +X side of the capturing unit 212, at positions corresponding to nodes of the standing wave SW.

In this case, the fluid S flowing through the positions of the nodes of the standing wave SW directly flows into the first flow path outlets 213A on the +X side. On the other hand, the fluid S flowing through positions of antinodes of the standing wave SW is guided to the second flow paths 22 by the wall portions 214. Accordingly, it is possible to further increase a fine particle concentration of the fluid S flowing out from the first flow path outlets 213A.

The same applies to the second embodiment, and the first flow path outlets 213A may be formed corresponding to the positions of the antinodes of the standing wave SW formed by the capturing unit 212. In this case, the fluid S flowing through the positions of the nodes of the standing wave SW is guided to the second flow paths 22 by the wall portions 214.

### Second Modification

In the first embodiment, an example has been shown in which the second flow paths 22 are connected to positions of antinodes of the standing wave SW, but the second flow paths 22 may be connected to any one or more of the plurality of antinodes.

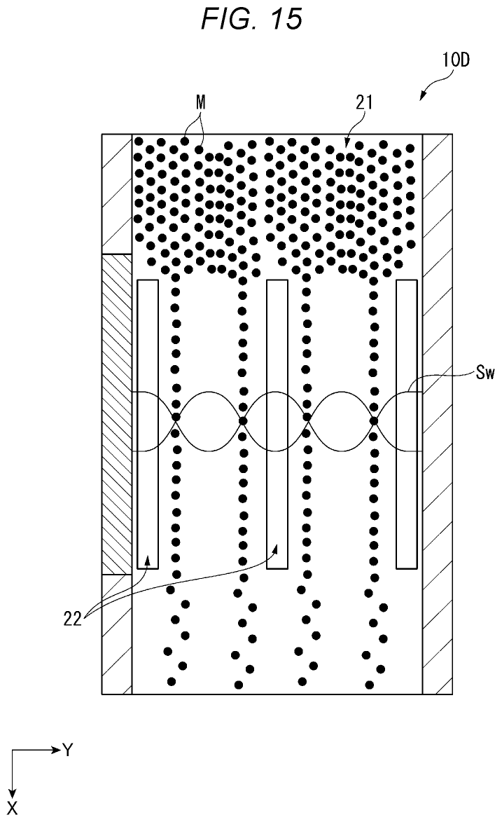

FIG. 15 is a cross-sectional view showing a schematic configuration of a fluid device 10D according to a second modification.

For example, as shown in FIG. 15, the second flow paths 22 may be connected to the first flow path 21 corresponding to odd-numbered antinodes among the plurality of antinodes of the standing wave SW generated along a Y direction.

### Third Modification

In the first embodiment, an example has been shown in which the fluid device 10 is disposed with the +X side facing vertically downward, but the present disclosure is not limited thereto. For example, when a size and weight of the fine particles M to be captured by an ultrasonic wave, which are contained in the fluid S, are sufficiently small, a −X side may be vertically downward, a Y direction (a +Y side or a −Y side) or a Z direction (a +Z side or a −Z side) may be vertically downward.

The same applies to the second to fourth embodiments.

### Fourth Modification

In the fourth embodiment, a configuration has been shown in which the mode orders of the first standing wave SW1 generated by the first ultrasonic element 40 and the second standing wave SW2 generated by the second ultrasonic element 40A are the same, and in which the first flow path outlets 213A connect positions corresponding to nodes of the first standing wave SW1 and positions corresponding to nodes of the second standing wave SW2. However, the present disclosure is not limited thereto.

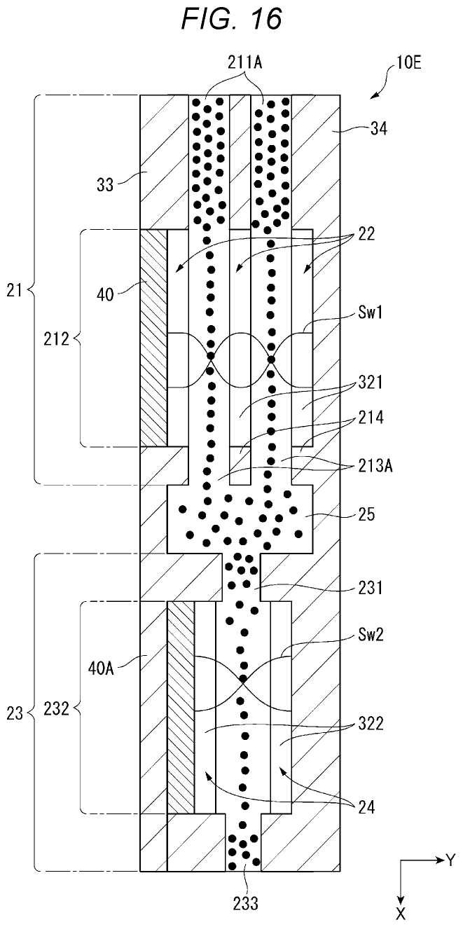

FIG. 16 is a cross-sectional view showing a schematic configuration of a fluid device 10E according to a fourth modification.

For example, in the fluid device 10E shown in FIG. 16, a mixing unit 25 is provided between the first flow path 21 and the third flow path 23. A plurality of first flow path outlets 213A formed corresponding to antinodes of the first standing wave SW are connected to a −X side of the mixing unit 25, and the mixing unit 25 mixes concentrated fluids flowing through the first flow path outlets 213. A third flow path introduction unit 231 is connected to a +X side of the mixing unit 25. The number of the third flow path introduction units 231 may be one or more.

Here, the mode orders of the first standing wave SW1 and the second standing wave SW2 may be different from each other. For example, in the fluid device 10E, since a diluted fluid is branched from the first flow path 21 to the second flow path 22, a flow rate of the fluid S flowing into the mixing unit 25 decreases. Therefore, it is preferable that a flow path width of the second capturing unit 232 in a Y direction or a Z direction is, or both flow path widths of the second capturing unit 232 in the Y direction and the Z direction are formed smaller than that of the capturing unit 212, and the mode order of the second standing wave SW2 is also smaller than that of the first standing wave SW1. For example, in the example shown in FIG. 16, the first standing wave SW1 is a secondary standing wave, whereas the second standing wave SW2 is a primary standing wave, the number of first flow path outlets 213 is two, and the number of third flow path introduction units 231 is one.

When there are a plurality of nodes of the second standing wave SW2, a plurality of third flow path introduction units 231 may be provided corresponding to the nodes. Alternatively, as in the first embodiment and the second embodiment, the flow path width of the third flow path introduction unit 231 in the Y direction may be the same as the flow path width of the second capturing unit 232.

In this example, the mode order of the second standing wave SW2 is smaller than that of the first standing wave SW1, but the present disclosure is not limited thereto. For example, a plurality of first flow paths 21 may be provided in parallel, and a plurality of first flow path outlets 213 connected to the first flow paths 21 may be connected to one mixing unit 25. In this case, a flow rate of the fluid S may increase depending on the number of the first flow paths 21 connected to the mixing unit 25. In this case, it is preferable that the flow path width of the second capturing unit 232 is also widened. In addition, the mode order of the second standing wave SW2 may be the same as that of the first standing wave SW1, or the mode order of the second standing wave SW2 may be larger than that of the first standing wave SW1.

As in the fourth modification, when the first flow path 21 and the third flow path 23 are connected to each other through the mixing unit 25, the first standing wave SW1 and the second standing wave SW2 may be in different directions. For example, the first standing wave SW may be formed along a direction parallel to the Y axis, and the second standing wave SW2 may be formed along a direction parallel to the Z axis. In this case, the fourth flow paths 24 may be provided at positions corresponding to antinodes of the second standing wave SW2 and extend from the second capturing unit 232 to the +Y side or the −Y side. That is, the second branch holes 322 may be formed in the third wall portion 33 or the fourth wall portion 34.

### Fifth Modification

In the first embodiment, an example is shown in which the second flow paths 22 are connected to a −Z side of the capturing unit 212 on the first flow path 21. Alternatively, a plurality of second flow paths 22 may be provided in different directions. For example, in addition to the second flow paths 22 extending from the second wall portion 32 of the capturing unit 212 to the −Z side, the second flow paths 22 extending from the first wall portion 31 to the +Z side may be provided.

### Sixth Modification

In the fourth embodiment, an example has been shown in which the second flow paths 22 are provided at positions of antinodes of the first standing wave SW1 and the fourth flow paths 24 are provided at positions of antinodes of the second standing wave SW2, but the present disclosure is not limited thereto.

For example, the second flow paths 22 may be provided at positions of nodes of the first standing wave SW1, and the fourth flow paths 24 may be provided at positions of antinodes of the second standing wave SW2. Further, the second flow paths 22 may be provided at positions of antinodes of the first standing wave SW1, and the fourth flow path 24 may be provided at positions of nodes of the second standing wave SW2.

### Seventh Modification

In the first embodiment, an example is shown in which the particle removal apparatus 200 including the fluid device 10 is applied to the washing machine 100, but the present disclosure is not limited thereto.

The fluid device 10 and the particle removal apparatus 200 according to the present disclosure can be applied to any apparatus that removes fine particles from a fluid, and can be applied to, for example, a domestic waste water process apparatus that processes domestic waste water including brushing dust, washing water of a facial material, and the like, and an industrial waste water process apparatus that processes industrial waste water discharged in a washing process or the like in a factory.

### Overview of Present Disclosure

A fluid device according to a first aspect of the present disclosure includes: a first flow path that extends along a first axis and through which a fluid flows in a positive side of the first axis; a first ultrasonic element configured to cause a first standing wave to be generated along a second axis orthogonal to the first axis in the first flow path; and a second flow path connected to the first flow path such that the fluid flows therethrough and extending along a third axis intersecting a plane including the first axis and the second axis. A first connection port for connecting the first flow path and the second flow path is formed corresponding to a position of an antinode or a node of the first standing wave.

Accordingly, the flow path through which the fluid flows at the position of the node of the first standing wave and the flow path through which the fluid flows at the position of the antinode can be formed in different directions.

For example, when the first connection port that connects the first flow path and the second flow path is formed at the position of the node of the first standing wave, the fine particles flowing through the fluid are captured at the position of the node of the first standing wave and directly flow into the second flow path connected to the first flow path along the third axis. That is, a concentrated fluid having a high concentration of fine particles flows into the second flow path. On the other hand, at the position of the antinode of the first standing wave, since the fine particles are moved toward the node, the diluted fluid having a low concentration of the fine particles flows, and flows through the first flow path along the first axis as it is.

When the first connection port that connects the first flow path and the second flow path is formed at the position of the antinode of the first standing wave, the diluted fluid flows into the second flow path along a third axis, and the concentrated fluid flows into the first flow path along the first axis.

In any case, the second flow path is a flow path extending along the third axis intersecting the first axis and the second axis, and is implemented in a plane different from the first flow path. Therefore, as compared with the case in which the flow paths are implemented in the same plane, the flow path configuration of the flow paths can be simplified, and the fluid device can be miniaturized.

In the fluid device according to the present aspect, a length of the first connection port along the second axis is smaller than a half wavelength of the ultrasonic wave that forms the first standing wave.

Accordingly, the fine particles can appropriately flow through a desired flow path.

In the fluid device according to the present aspect, an end portion of the first connection port on a negative side of the first axis is positioned on a positive side of the first axis with respect to an end portion of the first ultrasonic element on the negative side of the first axis.

In a case in which the first flow path and the second flow path are connected at a position corresponding to the antinode of the first standing wave, the fine particles before being captured by the node of the first standing wave may flow into the second flow path. That is, when the end portion of the first connection port on the negative side of the first axis is positioned at the same position as the end portion of the first ultrasonic element on the negative side or positioned on the negative side, the fluid flowing along the positive side of the first axis may flow into the second flow path immediately after entering the formation position of the first standing wave. On the other hand, in the present aspect, since the end portion of the first connection port on the negative side of the first axis is positioned on the positive side with respect to the end portion of the first ultrasonic element on the negative side of the first axis, the fine particles in the fluid flowing along the positive side of the first axis are captured at the nodes of the first standing wave, and then the fluid is branched into the first flow path and the second flow path. Therefore, it is possible to prevent the flowing of the fine particles into the second flow path.

In the fluid device according to the present aspect, a plurality of fluid inflow parts into which the fluid flows, and the capturing unit to which the plurality of fluid inflow parts are connected and in which the first ultrasonic element is disposed are provided at the first flow path, and the plurality of fluid inflow parts are connected to the capturing unit corresponding to positions of nodes of the first standing wave.

Accordingly, the fine particles in the fluid flowing through the fluid inflow part are captured at the positions of the nodes of the first standing wave immediately after flowing into the capturing unit, and the concentrated fluid having a high concentration of the fine particles and the diluted fluid having a low concentration of the fine particles can be separated with higher accuracy. That is, the particle concentration in the concentrated fluid can be increased, and the particle concentration in the diluted fluid can be decreased.

The fluid device according to the present aspect includes: a third flow path that is disposed on the positive side of the first axis with respect to the first flow path and into which the fluid flowing through the first flow path toward the positive side of the first axis is introduced; a second ultrasonic element configured to cause a second standing wave to be generated along a fourth axis orthogonal to the first axis in the third flow path; and a fourth flow path connected to the third flow path such that the fluid can flow therethrough and extending along a fifth axis intersecting a plane including the first axis and the fourth axis. A second connection port for connecting the third flow path and the fourth flow path is formed corresponding to a position of an antinode or a node of the second standing wave.

In such a configuration, the fluid flowing into the first flow path on the positive side of the first axis is further introduced into the third flow path. The third flow path is provided with a configuration similar to that of the first flow path, that is, the second ultrasonic element that causes the second standing wave to be generated, and the fourth flow path that is provided at the position of the node or the antinode of the second standing wave and that branches from the third flow path. Accordingly, the fine particles can be more suitably separated from the fluid by the third flow path. For example, when a concentrated fluid is introduced from the first flow path to the third flow path, the concentrated fluid can be separated into a concentrated fluid having a higher concentration of fine particles and a diluted fluid. In addition, when the diluted fluid is introduced from the first flow path to the third flow path, a diluted fluid having a lower concentration, from which fine particles are further removed, can be taken out from the diluted fluid.

Even in this case, since the second flow path and the fourth flow path can be drawn out in a direction intersecting the first axis where the fluid is discharged from the third flow path, the flow path configuration of each flow path can be simplified.

In this aspect, the first axis is parallel to a vertical direction.

Accordingly, it is possible to prevent the inconvenience that the fine particles are moved in a direction away from the nodes of the first standing wave and the second standing wave due to the influence of gravity.

In this aspect, the third axis is parallel to a vertical direction.

In a case in which the second flow path is connected to the first flow path at the position of the node of the first standing wave, it is possible to guide the fine particles captured at the node to the second flow path not only by the flow of the fluid but also by gravity, by setting a direction in which the fluid flows through the first flow path to the second flow path to a vertically downward direction.

A particle removal apparatus according to a second aspect of the present disclosure includes: the fluid device according to the first aspect; an injection unit configured to cause a fluid to flow into the fluid device; a first discharge unit configured to discharge a first fluid that flows out from the first flow path; a second discharge unit configured to discharge a second fluid that flows out from the second flow path; a first flow path forming unit configured to connect the first flow path and the first discharge unit; and a second flow path forming unit configured to connect the second flow path and the second discharge unit.

As described above, the first flow path and the second flow path of the fluid device are drawn out in different directions. Therefore, the first flow path forming unit and the second flow path forming unit can be independently formed in different planes, and the flow path configurations of the first flow path forming unit and the second flow path forming unit can be simplified.

A washing machine according to a third aspect of the present disclosure includes: the particle removal apparatus according to the second aspect; and a washing tub configured to wash clothes. The injection unit causes washing waste water from the washing tub to flow into the fluid device.

In this aspect, the washing waste water discharged from the washing tub of the washing machine is introduced into the fluid device from the injection unit. Accordingly, it is possible to suitably remove fine microplastic fibers contained in the washing waste water, and it is possible to contribute to the improvement of marine contamination.

What is claimed is:

1. A fluid device comprising:
a first flow path that extends along a first axis and through which a fluid flows in a positive side of the first axis;
a first ultrasonic element configured to generate a first standing wave along a second axis orthogonal to the first axis in the first flow path; and
a second flow path connected to the first flow path such that the fluid flows therethrough and extending along a third axis intersecting a plane including the first axis and the second axis, wherein
a first connection port for connecting the first flow path and the second flow path is formed corresponding to a position of either an antinode of the first standing wave or a node of the first standing wave.

2. The fluid device according to claim 1, wherein
a length of the first connection port along the second axis is smaller than a half wavelength of an ultrasonic wave that forms the first standing wave.

3. The fluid device according to claim 1, wherein
an end portion of the first connection port on a negative side of the first axis is positioned on the positive side of the first axis with respect to an end portion of the first ultrasonic element on the negative side of the first axis.

4. The fluid device according to claim 2, wherein
an end portion of the first connection port on a negative side of the first axis is positioned on the positive side of the first axis with respect to an end portion of the first ultrasonic element on the negative side of the first axis.

5. The fluid device according to claim 1, wherein
a plurality of fluid inflow parts into which the fluid flows, and a capturing unit to which the plurality of fluid inflow parts are connected and in which the first ultrasonic element is disposed are provided at the first flow path, and
the plurality of fluid inflow parts are connected to the capturing unit corresponding to positions of nodes of the first standing wave.

6. The fluid device according to claim 4, wherein
a plurality of fluid inflow parts into which the fluid flows, and a capturing unit to which the plurality of fluid inflow parts are connected and in which the first ultrasonic element is disposed are provided at the first flow path, and
the plurality of fluid inflow parts are connected to the capturing unit corresponding to positions of nodes of the first standing wave.

7. The fluid device according to claim 1, further comprising:
a third flow path that is disposed on the positive side of the first axis with respect to the first flow path and into which the fluid flowing from the first flow path toward the positive side of the first axis is flowed;
a second ultrasonic element configured to generate a second standing wave along a fourth axis orthogonal to the first axis in the third flow path; and
a fourth flow path connected to the third flow path such that the fluid flows therethrough and extending along a fifth axis intersecting a plane including the first axis and the fourth axis, wherein
a second connection port for connecting the third flow path and the fourth flow path is formed corresponding to a position of either an antinode of the second standing wave or a node of the second standing wave.

8. The fluid device according to claim 6, further comprising:
a third flow path that is disposed on the positive side of the first axis with respect to the first flow path and into which the fluid flowing from the first flow path toward the positive side of the first axis is flowed;
a second ultrasonic element configured to generate a second standing wave along a fourth axis orthogonal to the first axis in the third flow path; and
a fourth flow path connected to the third flow path such that the fluid flows therethrough and extending along a fifth axis intersecting a plane including the first axis and the fourth axis, wherein
a second connection port for connecting the third flow path and the fourth flow path is formed corresponding to a position of either an antinode of the second standing wave or a node of the second standing wave.

9. The fluid device according to claim 1, wherein
the first axis is parallel to a vertical direction.

10. The fluid device according to claim 8, wherein
the first axis is parallel to a vertical direction.

11. The fluid device according to claim 1, wherein
the third axis is parallel to a vertical direction.

12. The fluid device according to claim 10, wherein the third axis is parallel to a vertical direction.

13. A particle removal apparatus comprising:
the fluid device according to claim 1;
an injection unit configured to cause the fluid to flow into the fluid device;
a first discharge unit configured to discharge a first fluid flowing out from the first flow path;
a second discharge unit configured to discharge a second fluid flowing out from the second flow path;
a first flow path forming unit configured to connect the first flow path and the first discharge unit; and
a second flow path forming unit configured to connect the second flow path and the second discharge unit.

14. A particle removal apparatus comprising:
the fluid device according to claim 12;
an injection unit configured to cause the fluid to flow into the fluid device;
a first discharge unit configured to discharge a first fluid flowing out from the first flow path;
a second discharge unit configured to discharge a second fluid flowing out from the second flow path;
a first flow path forming unit configured to connect the first flow path and the first discharge unit; and
a second flow path forming unit configured to connect the second flow path and the second discharge unit.

15. A washing machine comprising:
the particle removal apparatus according to claim 8; and
a washing tub configured to wash clothes, wherein
the injection unit causes washing waste water from the washing tub to flow into the fluid device.

16. A washing machine comprising:
the particle removal apparatus according to claim 14; and
a washing tub configured to wash clothes, wherein
the injection unit causes washing waste water from the washing tub to flow into the fluid device.
